(19) United States
(12) Patent Application Publication
(10) Pub. No.: US 2018/0236883 A1
(43) Pub. Date: Aug. 23, 2018

(54) FUEL CELL VEHICLE

(71) Applicant: Toyota Jidosha kabushiki Kaisha, Toyota-shi (JP)

(72) Inventors: Yosuke Kokubo, Toyota-shi (JP); Michito Norimoto, Miyoshi-shi (JP)

(73) Assignee: TOYOTA JIDOSHA KABUSHIKl KAISHA, Toyota-shi (JP)

(21) Appl. No.: 15/900,286

(22) Filed: Feb. 20, 2018

(30) Foreign Application Priority Data
Feb. 21, 2017 (JP) 2017-029571

(51) Int. Cl. B60L 11/18; H01M 16/00; H01M 8/04858; H01M 10/46

(52) U.S. Cl. CPC B60L 11/1809; B60L 11/1887; H01M 16/006; H01M 2250/20; H01M 10/46; H01M 2220/20; H01M 8/04932

(57) ABSTRACT

A fuel-cell vehicle includes a fuel cell, a secondary battery, a drive motor that is supplied with electric power from the fuel cell and the secondary battery, and a controller that controls electric power which is supplied from the fuel cell and the secondary battery to the drive motor. The controller is configured to charge the secondary battery such that a state of charge of the secondary battery is maintained in a predetermined range when it is predicted that the fuel-cell vehicle is to travel on an uphill road and to supply at least a part of the electric power, which is supplied to the drive motor when the fuel-cell vehicle travels on the uphill road, from the secondary battery.

### INCORPORATION BY REFERENCE

The disclosure of Japanese Patent Application No. 2017-029571 filed on Feb. 21, 2017 including the specification, drawings and abstract is incorporated herein by reference in its entirety.

### BACKGROUND

### 1. Technical Field

The disclosure relates to a fuel-cell vehicle.

### 2. Description of Related Art

A fuel-cell vehicle in which a fuel cell and a secondary battery are mounted and which includes a drive motor that drives the fuel-cell vehicle using electric power supplied from the fuel cell and the secondary battery is known (Japanese Patent Application Publication No. 2012-244713 (JP 2012-244713 A)).

### SUMMARY

In the fuel-cell vehicle disclosed in JP 2012-244713 A, when an uphill road is detected, an amount of electric power which is supplied from the fuel cell to the drive motor is increased. When an amount of electric power generated by the fuel cell is increased, the temperature of the fuel cell may rise. When the fuel cell is in a high temperature state, a drying-up phenomenon in which water is excessively vaporized from an electrolyte membrane occurs, which decreases power generation efficiency in the fuel cell and thus a satisfactory amount of electric power may not be supplied to the drive motor. In order to solve such a problem, there is demand for a technique capable of supplying a satisfactory amount of electric power to a drive motor and restraining a fuel cell from entering a high temperature state.

The disclosure is made to solve at least a part of the above-mentioned problems and can be embodied in the following aspects.

An aspect of the disclosure is related to a fuel-cell vehicle. The fuel-cell vehicle includes a fuel cell that generates electric power using reactant gases, a secondary battery that is able to store and discharge electric power, a drive motor that is supplied with electric power from the fuel cell and the secondary battery and drives the fuel-cell vehicle, and a controller that controls electric power which is supplied from the fuel cell and the secondary battery to the drive motor. The controller is configured to charge the secondary battery such that a state of charge of the secondary battery is equal to or greater than a first lower limit and is equal to or less than a first upper limit when it is predicted that the fuel-cell vehicle is not to travel on an uphill road in a predetermined section based on position information and map information of the fuel-cell vehicle. The controller is configured to charge the secondary battery such that the state of charge of the secondary battery is equal to or greater than a second lower limit and is equal to or less than the first upper limit when it is predicted that the fuel-cell vehicle is to travel on the uphill road in the predetermined section based on the position information and the map information, the second lower limit being greater than the first lower limit and being less than the first upper limit. The controller is configured to supply at least a part of the electric power, which is supplied to the drive motor when the fuel-cell vehicle travels on the uphill road, from the secondary battery.

According to this aspect, before the fuel-cell vehicle travels on an uphill road, the secondary battery is charged such that the state of charge of the secondary battery is equal to or greater than the second lower limit, which is greater than the first lower limit and is less than the first upper limit, and is equal to or less than the first upper limit. Accordingly, when the fuel-cell vehicle travels on the uphill road, it is possible to prevent an amount of electric power generated by the fuel cell from increasing by supplying electric power from the satisfactorily charged secondary battery to the drive motor. As a result, it is possible to supply a satisfactory amount of electric power to the drive motor and to restrain the fuel cell from entering a high temperature state.

Another aspect of the disclosure is related to a fuel-cell vehicle. The fuel-cell vehicle includes a fuel cell that generates electric power using reactant gases, a secondary battery that is able to store and discharge electric power, a drive motor that is supplied with electric power from the fuel cell and the secondary battery and drives the fuel-cell vehicle, and a controller that controls electric power which is supplied from the fuel cell and the secondary battery to the drive motor. The controller is configured to charge the secondary battery such that a state of charge of the secondary battery is equal to or greater than a first lower limit and is equal to or less than a first upper limit when it is predicted that the fuel-cell vehicle is not to travel on an uphill road in a predetermined section based on position information and map information of the fuel-cell vehicle. The controller is configured to charge the secondary battery such that the state of charge of the secondary battery is equal to or greater than the first upper limit and is equal to or less than a second upper limit when it is predicted that the fuel-cell vehicle is to travel on the uphill road in the predetermined section based on the position information and the map information, the second upper limit being greater than the first upper limit. The controller is configured to supply at least a part of the electric power, which is supplied to the drive motor when the fuel-cell vehicle travels on the uphill road, from the secondary battery.

According to this aspect, before the fuel-cell vehicle travels on an uphill road, the secondary battery is charged such that the state of charge of the secondary battery is equal to or greater than the first upper limit and is equal to or less than the second upper limit which is greater than the first upper limit. Accordingly, when the fuel-cell vehicle travels on the uphill road, it is possible to prevent an amount of electric power generated by the fuel cell from increasing by supplying electric power from the satisfactorily charged secondary battery to the drive motor. As a result, it is possible to supply a satisfactory amount of electric power to the drive motor and to further restrain the fuel cell from entering a high temperature state.

Another aspect of the disclosure is related to a fuel-cell vehicle. The fuel-cell vehicle includes a fuel cell that generates electric power using reactant gases, a secondary battery that is able to store and discharge electric power, a drive motor that is supplied with electric power from the fuel cell and the secondary battery and drives the fuel-cell vehicle, and a controller that controls electric power which is supplied from the fuel cell and the secondary battery to the drive motor. The controller is configured to charge the secondary battery such that a state of charge of the secondary battery is equal to or greater than a first lower limit and is equal to or less than a first upper limit when it is predicted that the fuel-cell vehicle is not to travel on an uphill road in a predetermined section based on position information and map information of the fuel-cell vehicle. The controller is configured to charge the secondary battery such that the state of charge of the secondary battery is equal to or greater than a second lower limit and is equal to or less than the first upper limit when it is predicted that the fuel-cell vehicle is to travel on the uphill road in the predetermined section based on the position information and the map information and a gradient of the uphill road is less than a predetermined gradient, the second lower limit being greater than the first lower limit and being less than the first upper limit. The controller is configured to charge the secondary battery such that the state of charge of the secondary battery is equal to or greater than the first upper limit and equal to or less than a second upper limit when it is predicted that the fuel-cell vehicle is to travel on the uphill road in the predetermined section based on the position information and the map information and the gradient of the uphill road is equal to or greater than the predetermined gradient, the second upper limit being greater than the first upper limit. The controller is configured to supply at least a part of the electric power, which is supplied to the drive motor when the fuel-cell vehicle travels on the uphill road, from the secondary battery.

According to this aspect, before the fuel-cell vehicle travels on an uphill road, the secondary battery is charged such that the state of charge of the secondary battery is equal to or greater than the second lower limit, which is greater than the first lower limit and is less than the first upper limit, and is equal to or less than the first upper limit or the state of charge of the secondary battery is equal to or greater than the first upper limit and is equal to or less than the second upper limit which is greater than the first upper limit. Accordingly, when the fuel-cell vehicle travels on the uphill road, it is possible to prevent an amount of electric power generated by the fuel cell from increasing by supplying electric power from the satisfactorily charged secondary battery to the drive motor depending on the gradient of the uphill road. As a result, it is possible to supply a satisfactory amount of electric power to the drive motor and to restrain the fuel cell from entering a high temperature state.

The aspect of the disclosure is not limited to a fuel-cell vehicle, and can also be applied to various aspects such as a fuel-cell automobile and a fuel cell system for a fuel-cell vehicle. The disclosure is not limited to the above-mentioned aspects, and can be embodied in various forms without departing from the gist of the disclosure.

### BRIEF DESCRIPTION OF THE DRAWINGS

Features, advantages, and technical and industrial significance of exemplary embodiments of the disclosure will be described below with reference to the accompanying drawings, in which like numerals denote like elements, and wherein:

FIG. 1 is a diagram illustrating a configuration of a fuel-cell vehicle;

FIG. 2 is a flowchart illustrating an uphill road predicting process which is performed by an ECU;

FIG. 3 is a flowchart illustrating an uphill road predicting process which is performed by the ECU; and

FIG. 4 is a flowchart illustrating an uphill road predicting process which is performed by the ECU.

### DETAILED DESCRIPTION OF EMBODIMENTS

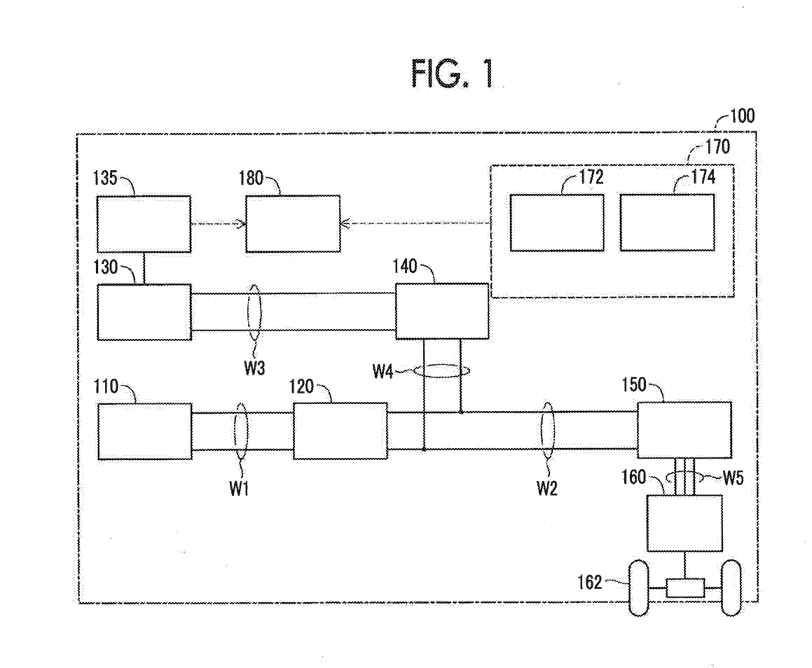

FIG. 1 is a diagram illustrating a configuration of a fuel-cell vehicle 100 according to an embodiment of the disclosure. The fuel-cell vehicle 100 is a vehicle that is driven by a drive motor 160 using a fuel cell 110 and a secondary battery 130 as power sources. The fuel-cell vehicle 100 includes a fuel cell 110, a fuel-cell converter 120, a secondary battery 130, an SOC detecting unit 135, a secondary battery converter 140, an inverter 150, a drive motor 160, vehicle wheels 162, a navigation device 170, and an electronic control unit (ECU) 180. The fuel-cell vehicle 100 further includes a DC wire W1, a DC wire W2, a DC wire W3, a DC wire W4, and an AC wire W5.

The fuel cell 110 is a solid polymer type fuel cell that is supplied with hydrogen gas and oxygen gas and generates electric power from an electrochemical reaction between hydrogen and oxygen. The fuel cell 110 is not limited to a solid polymer type fuel cell, and various types of fuel cells can be employed as the fuel cell. For example, a solid oxide type fuel cell may be employed instead of a solid polymer type fuel cell as the fuel cell 110. The fuel cell 110 is electrically connected to the fuel-cell converter 120 via the DC wire W1.

The fuel-cell converter 120 is a step-up type converter device and steps up a voltage output from the fuel cell 110. The fuel-cell converter 120 is electrically connected to the inverter 150 via the DC wire W2.

The secondary battery 130 is a battery that can store and discharge electric power. The secondary battery 130 along with the fuel cell 110 serves as a power source of the fuel-cell vehicle 100. In this embodiment, the secondary battery 130 includes a lithium-ion battery. In other embodiments, the secondary battery 130 may be other types of batteries such as a lead storage battery, a nickel-cadmium battery, and a nickel-hydride battery. The secondary battery 130 is electrically connected to the secondary battery converter 140 via the DC wire W3.

The SOC detecting unit 135 detects a state of charge (SOC) of the secondary battery 130 and transmits the detected SOC to the ECU 180. Here, the state of charge refers to a ratio of a residual charging capacity to a charging capacity to which the secondary battery 130 can be charged. The SOC detecting unit 135 detects a temperature, an output voltage, and an output current of the secondary battery 130 and detects the state of charge based on the detected values.

The secondary battery converter 140 is a step-up type converter device and has the same configuration as the fuel-cell converter 120. The secondary battery converter 140 is electrically connected to the DC wire W2, which connects the fuel-cell converter 120 to the inverter 150, via the DC wire W4. The secondary battery converter 140 adjusts a voltage of the DC wire W2 which is an input voltage of the inverter 150 to control charging and discharging of the secondary battery 130 in cooperation with the fuel-cell converter 120

When regenerative electric power is generated from the drive motor 160, the secondary battery converter 140 stores the regenerative electric power in the secondary battery 130. The secondary battery 130 may store the electric power of the fuel cell 110.

The inverter 150 converts DC power, which is supplied from the fuel cell 110 and the secondary battery 130 via the DC wire W2, to three-phase AC electric power. The inverter 150 is electrically connected to the drive motor 160 via the AC wire W5 and supplies the three-phase AC electric power to the drive motor 160. The inverter 150 converts the regenerative electric power generated from the drive motor 160 into DC power and outputs the DC power to the DC wire W2.

The drive motor 160 is an electric motor that converts the three-phase AC electric power supplied from the inverter 150 into rotational power. The vehicle wheels 162 are driven using the rotational power generated from the drive motor 160.

The navigation device 170 is a so-called car navigation system that performs route display or voice guidance via a display which is provided in a passenger cabin of the fuel-cell vehicle 100. The navigation device 170 includes a position information detecting unit 172 and a map information storage unit 174.

The position information detecting unit 172 detects position information of the fuel-cell vehicle 100. The map information storage unit 174 stores map information. The map information includes, for example, various planimetric objects which need to be marked on a map. Examples of the planimetric objects include artificial objects such as buildings and roads and natural objects such as mountains, streams, grasses, and trees. Relevant information of elements of the map information includes a variety of information which needs to be recorded as map information of the elements. For example, when a planimetric object is a building, the relevant information includes information on a shape, a width, a depth, a height, a height difference from a road on which the building borders, an entrance position, a site shape, a site width, a site depth, an address, a site number, residents, and the like of the building. When a planimetric object is a road, the relevant information includes a shape, a width, a length, a height, a name, a type (a national road, a prefectural road, or a public road), the number of lanes, presence of a median strip, presence of a sidewalk, presence of traffic lights, and a side ditch of the road.

The ECU 180 is a controller that receives signals output from various sensors disposed in the fuel-cell vehicle 100 and controls operations of the units of the fuel-cell vehicle 100. The ECU 180 controls a ratio between the electric power supplied from the fuel cell 110 and the electric power supplied from the secondary battery 130 in the electric power supplied from the fuel cell 110 and the secondary battery 130 to the drive motor 160. The ECU 180 controls the state of charge of the secondary battery 130 based on a signal which indicates position information and map information and which is output from the navigation device 170.

The ECU 180 performs the following process based on the signal which indicates position information and map information and which is output from the navigation device 170. That is, the ECU 180 charges the secondary battery 130 such that the state of charge of the secondary battery 130 is maintained in a range of 45% to 60%, when it is predicted that the fuel-cell vehicle 100 will not travel on an uphill road within a range of less than 10 km on a guided route from a current location of the fuel-cell vehicle 100 to a destination. In this embodiment, 45% is an example of a “first lower limit” In this embodiment, 60% is an example of a “first upper limit.” A range of 45% to 60% of the state of charge of the secondary battery 130 is a range in which the fuel-cell vehicle 100 can travel normally.

Here, a range of less than 10 km on the guided route from a current location of the fuel-cell vehicle 100 to a destination is an example of a “predetermined section.” In another embodiment, the predetermined section may be a range over which the fuel-cell vehicle 100 can be predicted to travel within 15 minutes on the guided route from the current location of the fuel-cell vehicle 100 to a destination. In this way, it is assumed that the predetermined section is determined based on distance conditions and time conditions.

A state in which the secondary battery 130 is charged such that the state of charge of the secondary battery 130 is maintained in the range of 45% to 60% refers to a state in which the secondary battery 130 is supplied with electric power to charge the secondary battery 130 to a state of charge of 60% when the state of charge of the secondary battery 130 reaches 45%.

The ECU 180 performs the following process based on the signal which indicates position information and map information and which is output from the navigation device 170. That is, when the fuel-cell vehicle 100 is predicted to travel on an uphill road within a range of less than 10 km on the guided route from the current location of the fuel-cell vehicle 100 to a destination, the ECU 180 charges the secondary battery 130 such that the state of charge of the secondary battery 130 is maintained in a range of 55% to 60%. In this embodiment, 55% is an example of a “second lower limit.”

A state in which the secondary battery 130 is charged such that the state of charge of the secondary battery 130 is maintained in a range of 55% to 60% refers to a state in which the secondary battery 130 is supplied with electric power to charge the secondary battery 130 to a state of charge of 60% when the state of charge of the secondary battery 130 reaches 55%.

Here, the uphill road is, as an unrestricted example, a road having a gradient which ascends 5 meters or more with respect to a horizontal distance of 100 meters and having a length of 100 meters or more.

In this embodiment, the ECU 180 predicts whether the fuel-cell vehicle 100 will travel on an uphill road based on the signal which indicates position information and map information and which is output from the navigation device 170 when the car navigation device is performing guidance for a route to a destination. That is, the ECU 180 performs the prediction based on the position information of the fuel-cell vehicle 100 and whether an uphill road is present on a guided route to a destination.

In this embodiment, when an uphill road is present at a position in a range of less than 10 km on the guided route from the current location of the fuel-cell vehicle 100 to a destination, the ECU 180 predicts that the fuel-cell vehicle 100 will travel on an uphill road. In this embodiment, when an uphill road is not present at a position within a range of less than 10 km on the guided route from the current location of the fuel-cell vehicle 100 to a destination, the ECU 180 predicts that the fuel-cell vehicle 100 does not travel on an uphill road. In another embodiment, the distance, which is used as a reference for the ECU 180 to predict an uphill road, on the guided route from the current location of the fuel-cell vehicle 100 to a destination may be greater than 10 km or may be less than 10 km.

The ECU 180 mainly uses the electric power generated from the fuel cell 110 to charge the secondary battery 130 such that the state of charge of the secondary battery 130 is maintained in a range of 45% (or 55%) to 60%. When regenerative electric power is generated from the drive motor 160, the secondary battery 130 may be charged with the regenerative electric power.

When it is predicted that the fuel-cell vehicle 100 will travel on an uphill road, the ECU 180 supplies at least a part of the electric power, which is to be supplied to the drive motor 160, from the secondary battery 130 when the fuel-cell vehicle 100 is traveling on the uphill road. When the fuel-cell vehicle 100 travels on an uphill road, the electric power supplied to the drive motor 160 is determined depending on an amount of depression of an accelerator (not illustrated) of the fuel-cell vehicle 100.

The ECU 180 controls a ratio of the electric power supplied from the secondary battery 130 to the electric power supplied from the fuel cell 110 in the electric power supplied from the fuel cell 110 and the secondary battery 130 to the drive motor 160. In the fuel-cell vehicle 100, before the fuel-cell vehicle 100 travels on an uphill road, the secondary battery 130 is charged such that the state of charge of the secondary battery 130 is maintained in a range closer to the upper limit (a range of 55% to 60%) in the range (a range of 45% to 60%) which can be set as the state of charge of the secondary battery 130 during normal traveling. That is, the state of charge of the secondary battery 130 is maintained in a range which is higher than that during normal traveling. Accordingly, the ECU 180 can actively use the electric power supplied from the secondary battery 130 to supply electric power to the drive motor 160. Accordingly, since an increase in an amount of electric power generated from the fuel cell 110 can be prevented, it is possible to supply a satisfactory amount of electric power to the drive motor 160 and to restrain the fuel cell 110 from entering a high temperature state.

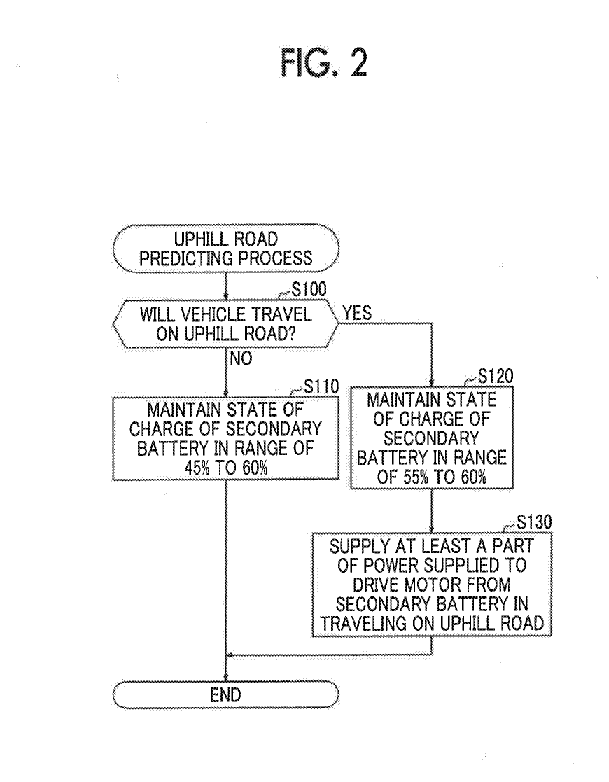

FIG. 2 is a flowchart illustrating an uphill road predicting process which is performed by the ECU 180. A step-up control process is repeatedly performed while the fuel-cell vehicle 100 is traveling.

When the uphill road predicting process is started, it is determined whether the fuel-cell vehicle 100 is predicted to travel on an uphill road (Step S100). When it is determined that the fuel-cell vehicle 100 is predicted not to travel on an uphill road (NO in Step S100), the ECU 180 charges the secondary battery 130 such that the state of charge of the secondary battery 130 is maintained in a range of 45% to 60% (Step S110). Thereafter, the uphill road predicting process illustrated in FIG. 2 ends.

When it is determined that the fuel-cell vehicle 100 is predicted to travel on an uphill road (YES in Step S100), the ECU 180 charges the secondary battery 130 such that the state of charge of the secondary battery 130 is maintained in a range of 55% to 60% (Step S120).

After the secondary battery 130 is charged such that the state of charge of the secondary battery 130 is maintained in a range of 55% to 60% (Step S120), the ECU 180 supplies at least a part of the electric power, which is supplied to the drive motor 160, from the secondary battery 130 when the fuel-cell vehicle 100 travels on the uphill road (Step S130). Thereafter, the uphill road predicting process illustrated in FIG. 2 ends.

According to the above-mentioned embodiment, before the fuel-cell vehicle 100 travels on an uphill road, the secondary battery 130 is charged such that the state of charge of the secondary battery 130 is maintained at a state of charge in a range of 55% to 60%. Accordingly, when the fuel-cell vehicle 100 travels on an uphill road, it is possible to prevent an increase in an amount of electric power generated by the fuel cell 110 by supplying electric power to the drive motor 160 from the secondary battery 130 which has been satisfactorily charged. As a result, it is possible to supply a satisfactory amount of electric power to the drive motor 160 and to restrain the fuel cell 110 from entering a high temperature state.

The fuel-cell vehicle 100 according to the first embodiment contributes to prevention of deterioration of a catalyst in the fuel cell 110. One cause of deterioration of a catalyst in the fuel cell 110 is output fluctuation of a cell voltage in the fuel cell 110. For example, in a case of a fuel-cell vehicle in which electric power is supplied to the drive motor 160 using only the fuel cell 110 when the vehicle travels on an uphill road, the output fluctuation of a cell voltage in the fuel cell 110 increases. That is, when a corresponding voltage is output from the fuel cell 110 every time there is traveling on an uphill road, the output fluctuation of the cell voltage in the fuel cell 110 increases. It is known that such output fluctuation causes deterioration of a catalyst. In the fuel-cell vehicle 100 according to the first embodiment, when the vehicle travels on an uphill road, at least a part of the electric power supplied to the drive motor 160 is supplied from the secondary battery 130. Accordingly, it is possible to reduce the output fluctuation of the cell voltage in the fuel cell 110. As a result, it is possible to prevent deterioration of a catalyst in the fuel cell 110.

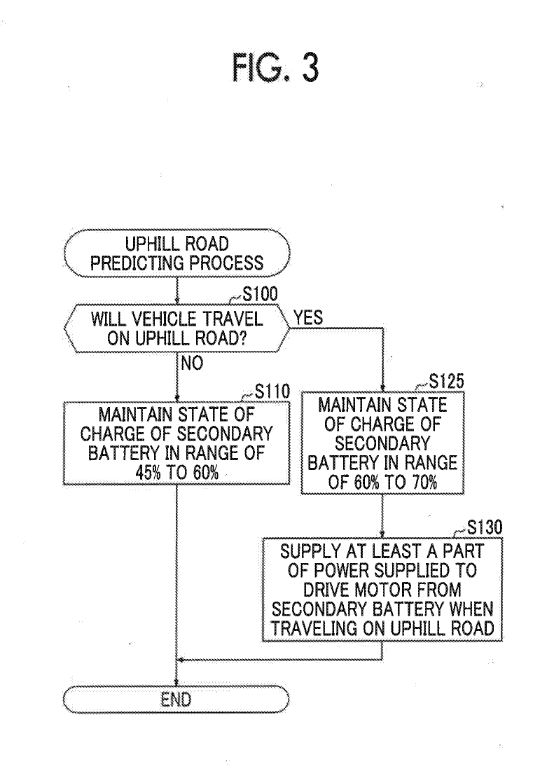

FIG. 3 is a flowchart illustrating an uphill road predicting process which is performed by an ECU 180 in a fuel-cell vehicle according to a second embodiment. The uphill road predicting process according to the second embodiment is the same as the uphill road predicting process according to the first embodiment, except that Step S125 is performed instead of Step S120 in the uphill road predicting process according to the first embodiment.

In the uphill road predicting process according to the second embodiment, when it is determined that the fuel-cell vehicle 100 is predicted to travel on an uphill road (YES in Step S100), the ECU 180 charges the secondary battery 130 such that the state of charge of the secondary battery 130 is maintained in a range of 60% to 70% (Step S125). In this embodiment, 70% is an example of a “second upper limit.” After the secondary battery 130 is charged such that the state of charge of the secondary battery 130 is maintained in a range of 60% to 70% (Step S125), the ECU 180 supplies at least a part of the electric power, which is supplied to the drive motor 160, from the secondary battery 130 when the fuel-cell vehicle 100 travels on the uphill road (Step S130), similarly to the first embodiment. Thereafter, the uphill road predicting process illustrated in FIG. 3 ends.

According to the above-mentioned embodiment, before the fuel-cell vehicle 100 travels on an uphill road, the secondary battery 130 is charged such that the state of charge of the secondary battery 130 is maintained at a state of charge in a range of 60% to 70%. That is, the secondary battery 130 is charged such that the state of charge of the secondary battery 130 is maintained in a range (a range of 60% to 70%) which is higher than a range (a range of 45% to 60%) which can be set as the state of charge of the secondary battery 130 during normal traveling. Accordingly, when the fuel-cell vehicle 100 travels on an uphill road, it is possible to prevent an increase in an amount of electric power generated by the fuel cell 110 by supplying electric power to the drive motor 160 from the secondary battery 130 which has been satisfactorily charged. As a result, it is possible to supply a satisfactory amount of electric power to the drive motor 160 and to restrain the fuel cell 110 from entering a high temperature state more reliably than in the first embodiment.

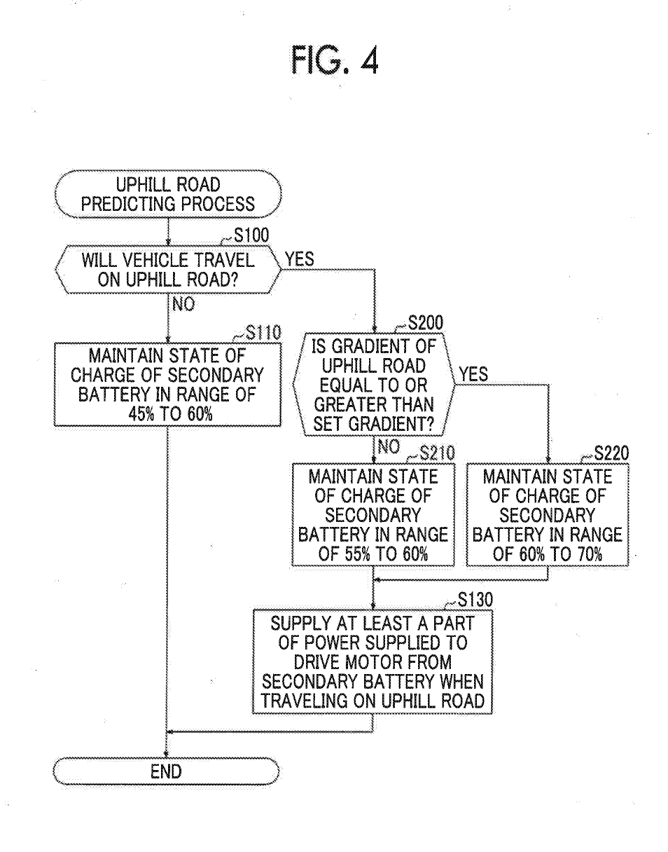

FIG. 4 is a flowchart illustrating an uphill road predicting process which is performed by an ECU 180 in a fuel-cell vehicle according to a third embodiment. The uphill road predicting process according to the third embodiment is the same as the uphill road predicting process according to the first embodiment, except that Steps S200, S210, and S220 are performed instead of Step S120 in the uphill road predicting process according to the first embodiment. Similarly to an uphill road in the first embodiment, an uphill road in the third embodiment is, as an unrestricted example, a road having a gradient which ascends 5 meters or more with respect to a horizontal distance of 100 meters and having a length of 100 meters or more.

In the uphill road predicting process according to the third embodiment, when it is determined that the fuel-cell vehicle 100 is predicted to travel on an uphill road (YES in Step S100), the ECU 180 determines whether the gradient of the uphill road is equal to or greater than a predetermined gradient (Step S200). Here, the predetermined gradient is, as an unrestricted example, a gradient which ascends 6 m with respect to a horizontal distance of 100 meters.

When it is determined that the gradient of the uphill road is less than the predetermined gradient (NO in Step S200), the ECU 180 charges the secondary battery 130 such that the state of charge of the secondary battery 130 is maintained in a range of 55% to 60% (Step S210).

When it is determined that the gradient of the uphill road is equal to or greater than the predetermined gradient (YES in Step S200), the ECU 180 charges the secondary battery 130 such that the state of charge of the secondary battery 130 is maintained in a range of 60% to 70% (Step S220).

After the secondary battery 130 is charged such that the state of charge of the secondary battery 130 is maintained in a range of 55% to 60% (Step S210) or after the secondary battery 130 is charged such that the state of charge of the secondary battery 130 is maintained in a range of 60% to 70% (Step S220), the ECU 180 supplies at least a part of the electric power, which is supplied to the drive motor 160, from the secondary battery 130 when the fuel-cell vehicle 100 travels on the uphill road (Step S130). Thereafter, the uphill road predicting process illustrated in FIG. 4 ends.

According to the above-mentioned embodiment, before the fuel-cell vehicle 100 travels on an uphill road, the secondary battery 130 is charged such that the state of charge of the secondary battery 130 is maintained at a state of charge in a range of 55% to 60% or a state of charge in a range of 60% to 70%. Accordingly, when the fuel-cell vehicle 100 travels on an uphill road, it is possible to prevent an increase in an amount of electric power generated by the fuel cell 110 by supplying electric power to the drive motor 160 from the secondary battery 130 which has been satisfactorily charged depending on the gradient of an uphill road. As a result, it is possible to supply a satisfactory amount of electric power to the drive motor 160 and to restrain the fuel cell 110 from entering a high temperature state more reliably.

In the first embodiment, when the car navigation device is performing guidance for a route to a destination, the ECU 180 predicts whether the fuel-cell vehicle 100 is to travel on an uphill road, but the disclosure is not limited thereto. For example, even when the car navigation device does not perform guidance for a route to a destination, the ECU 180 may predict whether the fuel-cell vehicle 100 is to travel on an uphill road based on the signal which indicates position information and map information and which is output from the navigation device 170. In such an embodiment, for example, an uphill road may be predicted based on whether an uphill road is included in a circle having a radius of a preset distance from a center which is a position of the fuel-cell vehicle 100 on a map. In a case of a public vehicle that travels on a determined route, the ECU 180 may determine that the vehicle is predicted to travel on an uphill road when the vehicle passes through a preset position on the determined route.

In the first embodiment, the position information detecting unit 172 and the map information storage unit 174 are a part of the navigation device 170, but the disclosure is not limited thereto. For example, in a fuel-cell vehicle 100 not including a navigation device, the position information detecting unit 172 and the map information storage unit 174 may be provided as independent elements in the fuel-cell vehicle 100.

In the first embodiment, when the fuel-cell vehicle 100 is predicted to travel on an uphill road, the ECU 180 charges the secondary battery 130 such that the state of charge of the secondary battery 130 is maintained in a range of 55% to 60%, but the disclosure is not limited thereto. For example, the secondary battery 130 may be charged such that the state of charge of the secondary battery 130 is maintained at 60% by extremely narrowing the range of the state of charge of the secondary battery 130.

In the above-mentioned embodiments, the fuel-cell vehicle 100 includes the position information detecting unit 172 and the map information storage unit 174 and the ECU 180 performs the uphill road predicting process based on the position information detected by the position information detecting unit 172 and the map information stored in the map information storage unit 174, but the disclosure is not limited thereto. For example, in an aspect in which the fuel-cell vehicle 100 includes only the position information detecting unit 172, map information stored in a server may be received, and the ECU 180 may perform the uphill road predicting process based on the map information and position information detected by the position information detecting unit 172. A server having received the position information detected by the position information detecting unit 172 in the fuel-cell vehicle 100 may perform an uphill road predicting process based on the map information stored in the server and the fuel-cell vehicle 100 may control charging of the secondary battery 130 based on the result of the uphill road predicting process received from the server.

The disclosure is not limited to the above-mentioned embodiments, examples, and modified examples, and can be embodied in various configurations without departing from the gist thereof. For example, technical features of the embodiments, examples, or modified examples corresponding to the technical features in the aspects described in the disclosure can be appropriately exchanged or combined to solve some or all of the above-mentioned problems or to achieve some or all of the above-mentioned advantages. The technical features can be appropriately deleted as long as they are not described to be essential in the specification.

What is claimed is:

1. A fuel-cell vehicle comprising:
a fuel cell that generates electric power using reactant gases;
a secondary battery that is able to store and discharge electric power;
a drive motor that is supplied with electric power from the fuel cell and the secondary battery and drives the fuel-cell vehicle; and
a controller that controls electric power which is supplied from the fuel cell and the secondary battery to the drive motor, wherein the controller is configured to:
i) charge the secondary battery such that a state of charge of the secondary battery is equal to or greater than a first lower limit and is equal to or less than a first upper limit when it is predicted that the fuel-cell vehicle is not to travel on an uphill road in a predetermined section based on position information and map information of the fuel-cell vehicle;
ii) charge the secondary battery such that the state of charge of the secondary battery is equal to or greater than a second lower limit and is equal to or less than the first upper limit when it is predicted that the fuel-cell vehicle is to travel on the uphill road in the predetermined section based on the position information and the map information, the second lower limit being greater than the first lower limit and being less than the first upper limit; and
iii) supply at least a part of the electric power, which is supplied to the drive motor when the fuel-cell vehicle travels on the uphill road, from the secondary battery.

2. A fuel-cell vehicle comprising:
a fuel cell that generates electric power using reactant gases;
a secondary battery that is able to store and discharge electric power;
a drive motor that is supplied with electric power from the fuel cell and the secondary battery and drives the fuel-cell vehicle; and
a controller that controls electric power which is supplied from the fuel cell and the secondary battery to the drive motor, wherein the controller is configured to:
i) charge the secondary battery such that a state of charge of the secondary battery is equal to or greater than a first lower limit and is equal to or less than a first upper limit when it is predicted that the fuel-cell vehicle is not to travel on an uphill road in a predetermined section based on position information and map information of the fuel-cell vehicle;
ii) charge the secondary battery such that the state of charge of the secondary battery is equal to or greater than the first upper limit and is equal to or less than a second upper limit when it is predicted that the fuel-cell vehicle is to travel on the uphill road in the predetermined section based on the position information and the map information, the second upper limit being greater than the first upper limit; and
iii) supply at least a part of the electric power, which is supplied to the drive motor when the fuel-cell vehicle travels on the uphill road, from the secondary battery.

3. A fuel-cell vehicle comprising:
a fuel cell that generates electric power using reactant gases;
a secondary battery that is able to store and discharge electric power;
a drive motor that is supplied with electric power from the fuel cell and the secondary battery and drives the fuel-cell vehicle; and
a controller that controls electric power which is supplied from the fuel cell and the secondary battery to the drive motor, wherein the controller is configured to:
i) charge the secondary battery such that a state of charge of the secondary battery is equal to or greater than a first lower limit and is equal to or less than a first upper limit when it is predicted that the fuel-cell vehicle is not to travel on an uphill road in a predetermined section based on position information and map information of the fuel-cell vehicle;
ii) charge the secondary battery such that the state of charge of the secondary battery is equal to or greater than a second lower limit and is equal to or less than the first upper limit when it is predicted that the fuel-cell vehicle is to travel on the uphill road in the predetermined section based on the position information and the map information and a gradient of the uphill road is less than a predetermined gradient, the second lower limit being greater than the first lower limit and being less than the first upper limit;
iii) charge the secondary battery such that the state of charge of the secondary battery is equal to or greater than the first upper limit and equal to or less than a second upper limit when it is predicted that the fuel-cell vehicle is to travel on the uphill road in the predetermined section based on the position information and the map information and the gradient of the uphill road is equal to or greater than the predetermined gradient, the second upper limit being greater than the first upper limit; and
iv) supply at least a part of the electric power, which is supplied to the drive motor when the fuel-cell vehicle travels on the uphill road, from the secondary battery.
